(19) United States
(12) Patent Application Publication
(10) Pub. No.: US 2013/0117153 A1
(43) Pub. Date: May 9, 2013

(54) FULLY INTERACTIVE, WIRELESS, RETAIL VIDEO DISPLAY TAG, INTEGRATED WITH CONTENT DISTRIBUTION, DATA MANAGEMENT, FEEDBACK DATA COLLECTION, INVENTORY AND PRODUCT PRICE SEARCH CAPABILITIES

(71) Applicant: JI SHEN, San Diego, CA (US)

(72) Inventor: JI SHEN, San Diego, CA (US)

(73) Assignee: Pathway Innovations and Technologies, Inc., San Diego, CA (US)

(21) Appl. No.: 13/661,540

(22) Filed: Oct. 26, 2012

Related U.S. Application Data
(60) Provisional application No. 61/555,574, filed on Nov. 4, 2011.

(51) Int. Cl. G06Q 30/00; G06Q 10/08

(52) U.S. Cl. 705/26.9; 705/28

(57) ABSTRACT

In the disclosed video display tag, a processor is wirelessly connected to a remote server. A video display screen and a motion sensor are coupled to the processor. The processor is configured to update the display screen in real-time with information relating to availability and/or character of a select product. Also included is a transmitter that sends the updated display screen information to remote users. The processor activates in response to a signal from the motion detector indicating that a human being is nearby the system.

The present application is a non-provisional application of U.S. Provisional Patent Application No. 61/555,574, filed Nov. 4, 2011, the entirety of the contents of which are hereby incorporated by reference.

### FIELD Retail display tools, video kiosk, interactive kiosk, digital media player, personal mobile computing devices.

### BACKGROUND

A traditional retail display tool is primarily the paper price tag. However, what can be displayed on a price tag is limited; not much more than the price, product name, and a bar code are possible. Shelf space is limited. Products don't just sell by sitting on a shelf. Signage and attention getters increase sales. A solution is hard to come by and expensive. FIG. 1 shows three examples of typical display tags 101, 102 and 103.

Electronic price tags have emerged. They are mostly small gray scale LCD displays similar to the panels used in a wristwatch. They display no more than the price, product name, and a bar code. FIG. 2 shows an example of a typical electronic price tag 201.

Video presentation of product data, similar to an infomercial, advertising clips, user's manual, endorsements, demonstrations, and user testimonials, all can significantly improve sales by supplying sufficient information to potential consumer buyers. However, traditionally, such a rich set of information is not possible to present at retail shelves where the product is physically present.

Furthermore, consumer feedback of products, reactions to certain ad or demonstration, has been difficult to collect, even though they are highly valuable to manufacturers and retailers. Fully interactive kiosks exist often with the form factor of a small photo booth standing on the floor. They present a rich and interactive experience. But they are too big and too expensive, which makes them only suitable for showcasing expensive products or being used as information booth.

The advent of wireless personal computing devices has reached a critical threshold, where powerful computing devices capable of processing general operating system tasks such as file management and user interface functions as well as full motion video playback, have become highly affordable for mass consumption. Consumers have seen highly powerful mobile phones running embedded Linux OS in below $40 price range. It is desirable to put a miniaturized wireless computer in front of every product on a retail shelf to fully showcase the product to achieve its sales potential.

From another perspective, consumers not only need sufficient, easy to understand information, and clear demonstration of a product, they also want to conveniently search and find out which retailer is carrying a product at any given time and whether the product is on the shelf, by using a web browser from home PCs, mobile phones, or tablet computers. Traditionally, such information is virtually impossible to access outside of large retailer's proprietary and closed internal information systems.

### SUMMARY

Disclosed is a video display tag that includes a processor that is wirelessly connected to a remote server. A video display screen and a motion sensor are coupled to the processor. The processor is configured to update the display screen in real-time with information relating to availability and/or character of a select product. Also included is a transmitter that sends the updated display screen information to remote users. The processor activates in response to a signal from the motion detector indicating that a human being is nearby the system.

In another embodiment a video display tag system includes a display monitor and a publicly accessible server coupled to the display monitor. The publicly accessible server is configured to display updated product information in real-time on the display monitor as product information changes. The publicly available server is further configured to transmit the updated product information to remote users.

A bar code reader can be attached to any of the embodiments. The processor would display information relating to a scanned bar code in response to the bar code's detection by the bar code reader. In other circumstances the processor would provide product information upon receipt of a stock keeping unit (SKU) number by a remote user.

A method of providing up-to-date product information to a user would include selecting a product and displaying a video relating to the product and the product's availability. Availability includes information such as how to use the product, ease of assembly or use, availability within a store's inventory, availability at other stores, user comments and feedback about the product, suggested companion products.

### BRIEF DESCRIPTION OF THE ACCOMPANYING DRAWINGS

FIG. 1 is a traditional retail price tag;

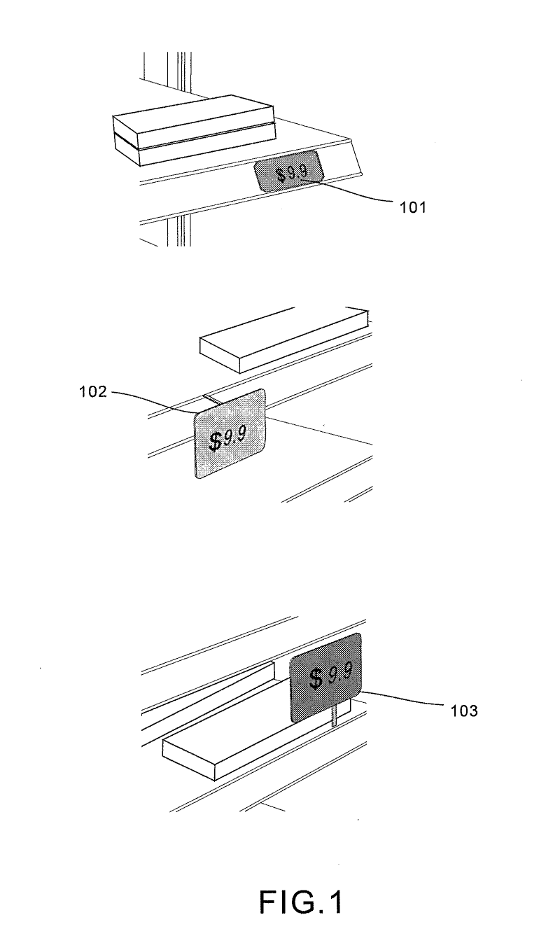

FIG. 2 is an existing electronic price tag;

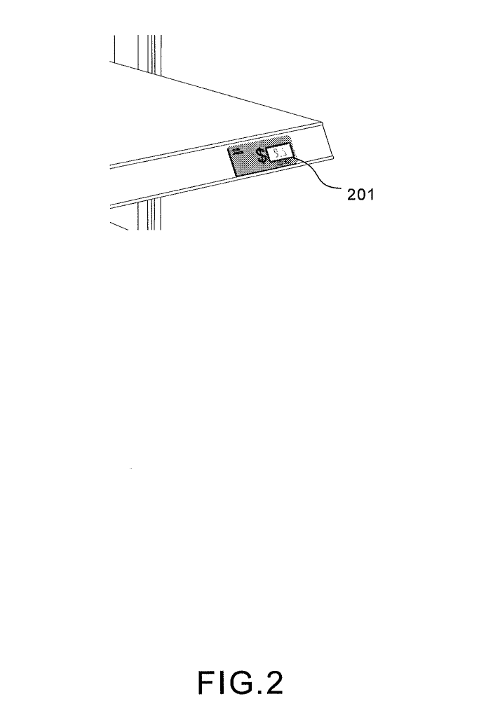

FIG. 3 is a single Video Tag Device;

FIG. 4 is an embodiment of possible mounting apparatus for the Video Tag Device;

FIG. 5 is an alternative mounting apparatus for the Video Tag Device;

FIG. 6 is a wireless Communication Network Diagram Linking the Video Tag Devices and the Server System;

FIG. 7 is a consumer viewing and interacting with the video tag device;

FIG. 8 is a consumer downloading content onto mobile device and view the content later;

FIG. 9 is a software logical diagram for the device;

FIG. 10 is a server software logical diagram for the device; and

FIG. 11 is an electronic Circuit Logical Diagram.

### DETAILED DESCRIPTION

The present system places a wireless mobile computing device in place of a price tag on retail shelves, potentially for every product/SKU. It is connected with an open back office management system wirelessly to have continuous content updated, collected and transmitted to and from customers.

The present system has a form factor that is slightly bigger or thicker than a typical credit card and it can be securely mounted on retail shelves and near end caps. It can play full motion video or it can present a slideshow of images. As such, it can display pricing and product information electronically.

The system has markings, such as a barcode, a serial number, radio frequency integrated circuit (RFIC) or 3G wireless integrated circuit, wireless pairing ID's, etc. so that a customer can identify the device and the corresponding product that is displayed on the video screen using a customer handheld bar code scanner or RFID scanner. On the other hand, the system has a barcode scanner, credit card reader, cash receptacle and other means of reading and accepting payment information from the customer. Advantageously, a customer can then buy a product right at the video display tag system.

The present system has internal storage of video or image files for playback. Motion sensors trigger playback of video when a customer is present, and lack of motion causes the system to go to “sleep” when no one is present.

Embodiments of the system enable wireless receipt and transmission of content from a server system. The content can be something that is locally collected such as shopper's habits, the number of times a display tag is passed and/or activated, and information relating to a product. Also, the system can have a front facing camera that can capture a customer's visual reactions to a product. A gesture recognition lookup table can be coupled to the system that can provide an image or response to the user based on and in response to the facial expressions of the customer. This includes being able to recognize when a customer's facial reaction is positive or negative via facial pattern recognition techniques.

The system can have a fully interactive user interface, with buttons and touchable screens that will allow a user to complete many functions such as looking up information on a product, transmission of product information to a smart phone and programming with particular product information. Buttons (mechanical, touch screen or other finger operated inputs) can capture consumer survey feedback on the spot, right at the video display tag.

When positioned on the shelf, the system has a “back facing camera,” i.e. the system has a camera that can capture images of what's being displayed on the shelf behind the display tag. This back facing camera can help visually recognize the approximate number and quality of inventory on a merchant's shelf. The advantage to this is that a person who is on the way to a store to pick up an item can get visual verification via smartphone or some other personal data assistant of the inventory left in the store.

Through a web address or phone number specific to the display tag, a remote user can connect to the display tag. Connectivity allows consumers to download video and other product information onto their mobile devices, such as an iPhone or an Android phone, for later viewing or record keeping. Connectivity also allows consumers to easily share the video content and URL web links to products via various communication means such as email, direct wireless transmission, etc.

The “back office” can be another name for a store office, control room or simply a remote or local server. The server manages the storage, distribution and update of video or image content onto respective display devices matching various products. This update can be done by the store, by the product supplier who has access to the server or by the customer (if allowed by a system administrator). Things such as pricing, product description, new product versions, etc. are updatable through the back office. As such, information is stored on the server, pricing, product description information, pricing and other product presentation content are available in open and searchable format.

The back office server also enables management of the collection, storage, distribution and presentation of user feedback statistics. As discussed above, feedback is likely collected through the local device via user text input, facial recognition, etc. Actual consumer comments are likely collected via web browsers.

An alternative embodiment of the system is one in which an ultra-low cost disposable display, such as an MP4 player or other recyclable device, is included in product packaging. For example, a home theatre or stereo system would include the disclosed device rather than a paper instruction manual. The device can be triggered by touch, light or a switch and configured with a tutorial video to help a customer set up a product—in this example, the stereo. It can even be configured with voice recognition that can trigger a “frequently asked questions” menu. Similar to above, using facial recognition techniques, the disposable system can have a camera that captures the facial expressions of a user in order to determine whether to offer help to a visibly perplexed customer.

Preferably, the disposable system will be mailed back to the product supplier for further use in other product packaging. Alternatively, the disposable system can be provided to a store to use as a video display tag as explained above. The store can even offer a deposit similar to returned aluminum cans.

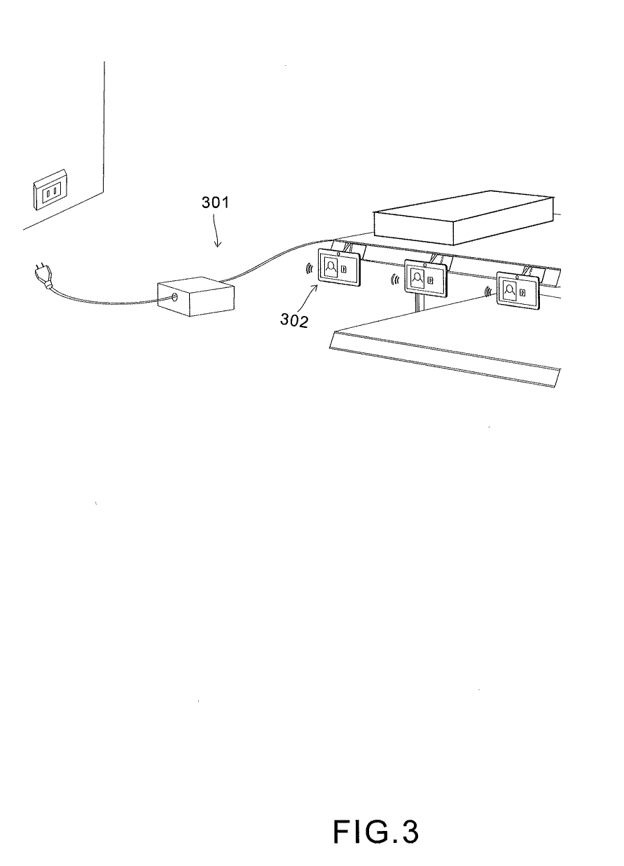

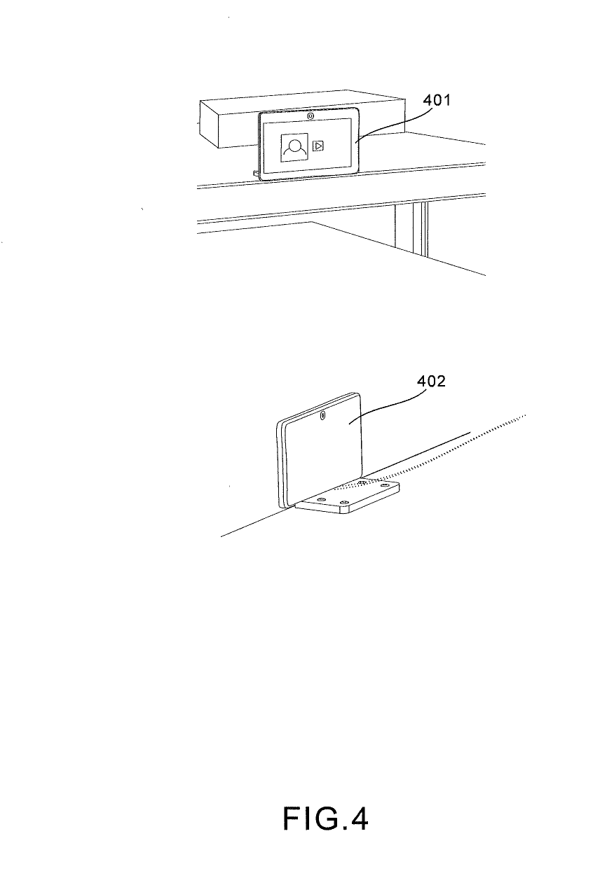

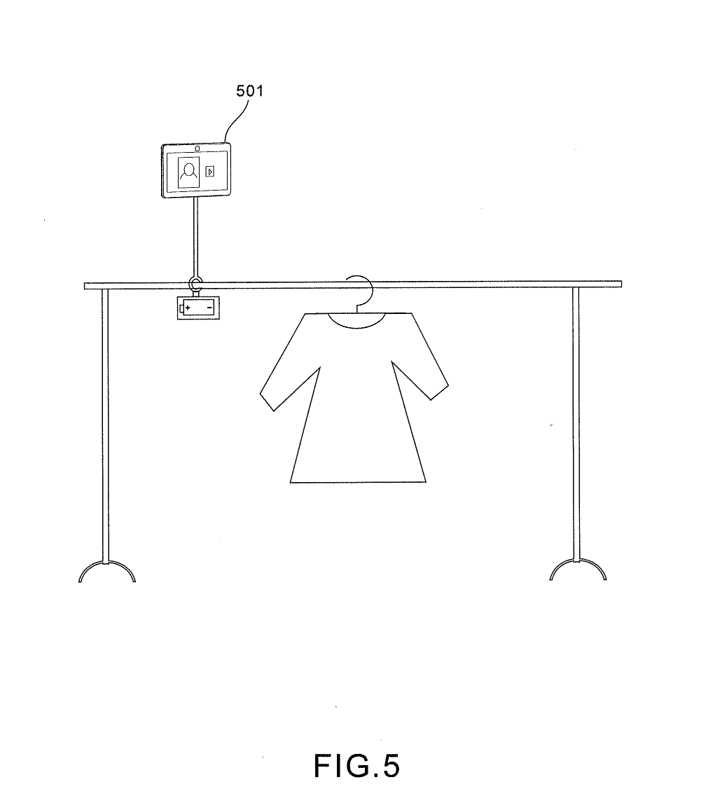

With reference to the figures, FIG. 3 is a depiction of an embodiment of a video display tag system 301 including a sliding video display screen 302. The screen is configured to engage with a shelf via a sliding tab on the back of the screen 302. Thus, store clerks can quickly change the screen if necessary. FIG. 4 shows a more permanent display screen 401 that is tacked to a shelf at its rear side 402 via screws or some other type of fastener. FIG. 5 shows a rack video display tag 501 that can be attached to a clothes rack and elevated via a post to average eye level to catch a customer's attention.

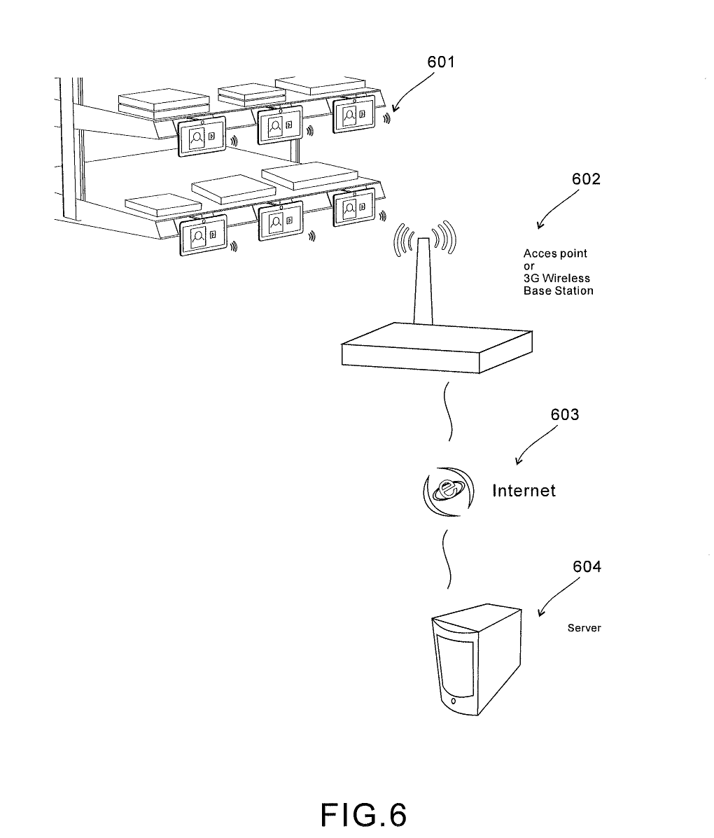

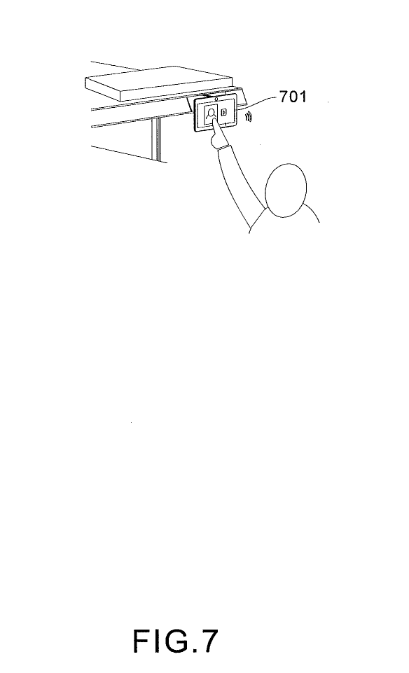

Communication to the “back office” is done through the internet via a 3G wireless base station as shown in FIG. 6 (this system is not limited to 3G; any other mobile telecommunications technology generation is available). The display tags are configured to send and receive signals 601 to and from the 3G wireless base station 602 through the internet 603. A server 604 at the back office collects and transmits data to be used on the display tag for display to a customer. As shown in FIG. 7, a customer would be able to view an update 701 to the video display tag as it occurs. There is no need to shut down the tag to update the displayed information.

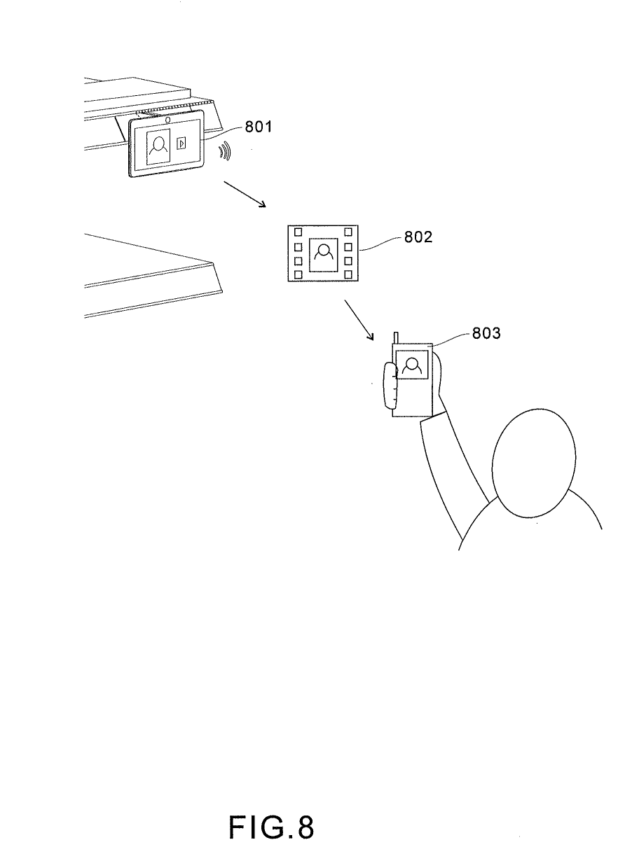

If a customer is interested in viewing information about a product at a later period, the customer can download the information from the video display tag to a personal data assistant or a smart phone for viewing later. As shown in FIG. 8, a request can be made to the video display tag 801 to send video information 802 about a product to a smartphone 803. The smartphone holding customer then can review product information at home including information that can be found on various internet sources about the product in general as well as information about a particular unit on the shelf including whether the product was previously bought and returned to the store by another customer.

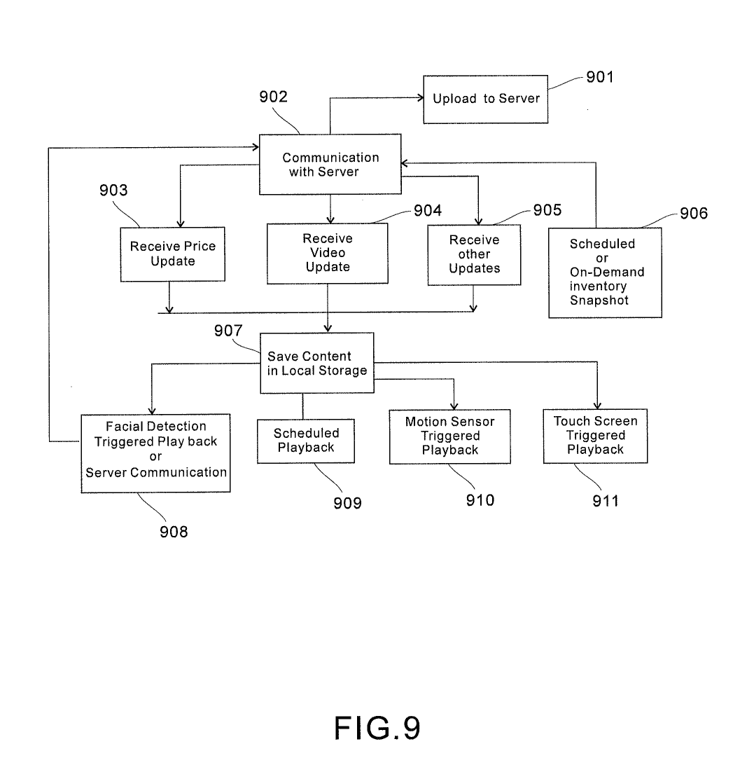

A method for maintaining an updated video display tag and back room server is shown in FIG. 9. A snapshot of inventory units is taken at step 906 and sent to a server in steps 901 and 902. The server can then update the video display tag with price, video or other updates at steps 903, 904 and/or 905. The video display tag has a local memory means such as a non-volatile hard drive on which the original inventory content as well as updates can be stored. Storing occurs at step 907. At data collection step 908, a customer's facial features are determined. If a particular facial contortion is discovered, one of various videos is selected for playback based on the facial contortion and played to a customer. Such a facial contortion is communicated to the back room server and stored therein. Alternatively, a video is played back in accordance with a predetermined schedule at step 909. In steps 910 and 911, respectively, a video is played in response to a motion sensor or in response to a touch screen request.

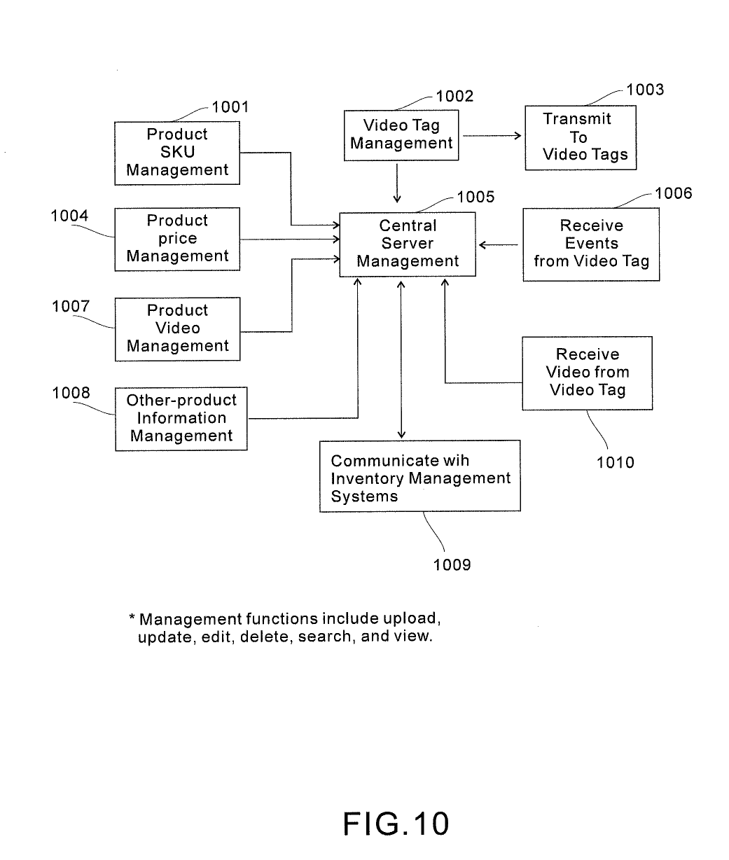

FIG. 10 shows a product price management diagram. Product SKU 1001, price 1004, related video 1007, and other product information 1008 are all managed via a central server 1005. A separate inventory management system 1009 communicates with the central server 1005. The central server receives video 1010 and events 1006 from the video display tag. Such events include number of requests for information, customer's facial expressions, etc. The central server 1005 updates a video tag management server 1002 and in return can be updated by the video tag management server 1002. The transmission 1003 occurs via wireless internet or any other form of electronic communication.

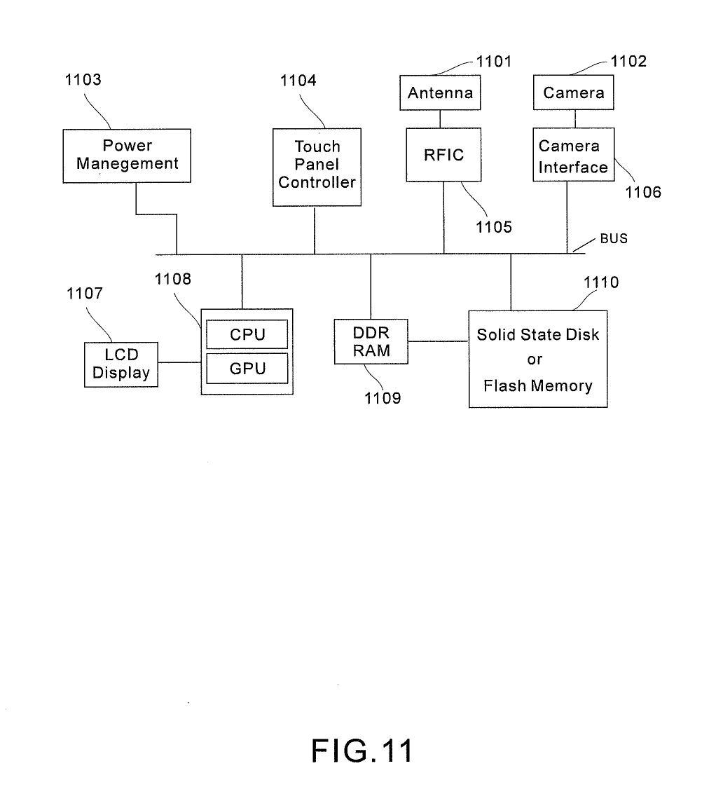

As shown in FIG. 11, the circuitry for the video display tag includes a power management component 1103, a touch panel 1104, RFID 1105 and antenna 1101, a camera interface 1106 and a camera 1102, an LCD display 1107, a processor 1108, memory 1109 and storage means 1110. The term “coupled” may be used herein to refer to any type of relationship, direct or indirect, between the components in question, and may apply to electrical, mechanical, fluid, optical, electromagnetic, electromechanical or other connections. In addition, the terms “first,” “second,” etc. might be used herein only to facilitate discussion, and carry no particular temporal or chronological significance unless otherwise indicated.

The technology disclosed in this document can expand to use in other applications. For example, it is envisioned that a restaurant table top can include a video display on which menus would be displayed. Cameras positioned in the table or somewhere nearby could capture a diner's response to food suggestions. Thus, rather than having a waiter or waitress on staff to take a person's order, a diner can simply order at the table directly to a kitchen or single wait staff. As diners often have special requests such as removing onions from a hamburger, the video display tag system can be configured to answer questions about food specials, menu items, etc.

Also, if video display tags can be placed in a restaurant's kitchen so that diners can see how clean a kitchen is and the cooking habits used by the chefs. Often a diner will comment on how they have to be nice to the wait staff or the wait staff will tamper with the food. Kitchen cameras that send images to dining tables can help eliminate this problem.

Another alternative use would be in singles' bars. Each person at a singles' bar would be given a portable video display tag with an RFID. The portable video display tag can be programmed with the holder's personal information such as likes, dislikes, mobile phone number, etc. It can be programmed to provide different levels of access to other users. For example, general bar patrons can be allowed access to likes and dislikes, but the tag holder would have to grant access to a person who desires a telephone number or email address.

Also, rather than have a portable display tag given to a user, a singles' bar patron can have a personal tag. In this way, before getting to a venue, the tag holder can connect with cameras at the venue to determine how many people are already there. If that person wants to advertise his or her arrival at the venue, he or she can send a general message to all of the patrons currently at the bar with an attached picture or video of himself as well as personal statistical information.

With further reference to a video display tag used in a shopping center, a portable “shopping assistant” is possible. The portable shopping assistant would be installed on shopping carts or handed to a shopper at the entrance to a store. As a result, the shopper can have video pushed to the portable shopping assistant when he or she gets close to a shelved video display tag. The shelved tag would emit a signal once it is triggered by an RFID of the shopper's portable shopping assistant.

Those skilled in the art will appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

I claim:

1. A video display tag comprising:
a processor wirelessly connected to a remote server,
a video display screen coupled to the processor, and
a motion sensor coupled to the processor configured to activate the display screen upon sensing motion within a predefined distance of the video display tag,
wherein the processor is configured to update the display screen in real-time with information relating to instantaneous characteristic of a product purported to be in a merchant's inventory.

2. The video display tag as recited in claim 1 further comprising a transmitter for sending the updated display screen information to remote users.

3. The video display tag as recited in claim 1 wherein the processor is configured to activate in response to a signal from the motion detector indicating that a human being is nearby the system.

4. The video display tag as recited in claim 1 further comprising a camera directed at a product in a predetermined radius of the video display tag to provide actual product availability to a user.

5. The video display tag as recited in claim 4 wherein the remote servers is coupled to a plurality of video display screens.

6. The video display tag as recited in claim 5 wherein the processor is configured to provide a plurality of locations to a remote user, each location having a like product respective to every other location, the plurality of locations provided to the user sorted nearest to farthest from the user.

7. The video display tag as recited in claim 1, wherein the instantaneous characteristic is selected from the group consisting of an amount of product in stock, quality of remaining product units, price of product, future price discounts and equivalent product alternatives.

8. A video display tag system comprising:
a display monitor; and
a publicly accessible server coupled to the display monitor;
wherein the publicly accessible server is configured to display updated product information in real-time on the display monitor as product information changes.

9. The video display tag system as recited in claim 8 wherein the publicly available server is further configured to transmit the updated product information to remote users.

10. The video display tag system as recited in claim 8 further comprising a motion detector coupled to the processor, wherein the processor is configured to activate in response to a signal from the motion detector indicating that a human being is nearby the system.

11. The video display tag system as recited in claim 8 further comprising a bar code reader.

12. The video display tag system as recited in claim 11 wherein the processor is configured to display information relating to a scanned bar code in response to the bar code's detecting by the bar code reader.

13. The video display tag system as recited in claim 8 wherein the processor is configured to provide product information upon receipt of a stock keeping unit (SKU) number by a remote user.

14. The video display tag system as recited in claim 8 wherein the product information is selected from the group consisting of an amount of product in stock, quality of remaining product units, price of product, future price discounts and equivalent product alternatives.
